(19) United States
(12) Patent Application Publication
(10) Pub. No.: US 2025/0378424 A1
(43) Pub. Date: Dec. 11, 2025

(54) AI ENABLED COMPETENCY BASED FLEX CURRICULUM PLANNER

(71) Applicant: Arizona Board of Regents on Behalf of Northern Arizona University, Flagstaff, AZ (US)

(72) Inventors: José Luis CRUZ-RIVERA, Flagstaff, AZ (US); Michelle GENEVA-PARKER, Flagstaff, AZ (US); Steven BURRELL, Flagstaff, AZ (US)

(21) Appl. No.: 19/232,588

(22) Filed: Jun. 9, 2025

Related U.S. Application Data
(60) Provisional application No. 63/657,628, filed on Jun. 7, 2024.

(51) Int. Cl. G06Q 10/1093; G06Q 10/0639; G06Q 50/20

(52) U.S. Cl. CPC G06Q 10/1093; G06Q 10/06393; G06Q 50/205

(57) ABSTRACT

A system and computer implemented method is described for matching educational institution applicant experience and background to coursework at post-secondary institutions. The system accepts as input applicant data such as resumes and previous educational transcripts. These data are formatted and transformed into competencies or skills of the applicant. Course data is also transformed into competencies or skills. The system matches students to courses at the level of skills and competencies. Full or partial credit may be awarded on the basis of the matching.

### CROSS-REFERENCE TO RELATED APPLICATIONS

The present application claims priority to U.S. Provisional Application 63/657,628 of the same title, filed on Jun. 7, 2024, the contents of which is incorporated herein by reference in its entirety.

### BACKGROUND

The economy today may be characterized by two significant trends: the rise of artificial intelligence that has the capacity to perform the intellectual labor currently done by millions of workers and accelerating technological change and challenges in other fields. These two trends require that workers constantly be sharpening their skills and knowledge so as to maintain their economic value. In recognition of this, post-secondary educational institutions are increasingly tailoring educational services to mid-career students seeking to learn new skills and to gain new certifications. This work is complementary to a resurgent focus in post-secondary institutions on workforce development and training, for both four-year and two-year institutions.

A typical mid-career student, or any other student with a significant pre-college work or educational history, will oftentimes apply to a degree or certification program at a two-year community or four-year institution. These certification or degree programs are, due to historical necessity, typically tailored to pre-career students arriving immediately from secondary school. Putting aside high school dual credit courses and Advanced Placement testing, traditional students arriving from High School will generally not have significant coursework at the college level, so they will be required to successfully complete the entirety of a degree program.

The situation should be different for mid-career students, returning students, or other individuals with significant career experience, however, translating a mid-career student's job-based skills and accomplishments into college credit is a challenging task, both conceptually and practically.

### SUMMARY

In one embodiment, the invention includes an AI or LLM-based system that accepts as input one or more applicant experience datasets. The applicant experience datasets may include a resume or CV, one or more transcripts reflecting previous academic coursework, documentation regarding educational and/or occupational certifications earned by the applicant, and data regarding the applicant's career. One more of these datasets may be subject to pre-search processing to map certain keywords and key phrases to other searchable key words or key phrases. The datasets, either pre- or post-processing, are matched to course offering datasets to determine whether and the degree to which the applicant's experiences correspond to coursework offerings, such that the applicant can receive credit toward certain coursework on the basis of their experience. In one embodiment, this matching step comprises decomposing some or all of the applicant experience datasets into competencies, which are compared with similarly competencies that are disaggregated from coursework. In these cases, matching may be performed at the competency level. A partial match between applicant experience and coursework may be determined by matching one more applicant competencies to competencies taught in a course, but where there is not a match to some course competencies. In certain cases, course credit may be provided to or proposed to an applicant based on a complete match. In some cases, a complete match may result in an invitation to take an examination for course credit (i.e., to “test out”). In partial match cases, the applicant may be given a short course of self-study, followed by an exam, in order to acquire and demonstrate proficiency in the unmatched competencies. At the completion of these steps, the student may be awarded course credit.

In other embodiments, the system may assemble courses on a flexible, ad hoc basis from decomposed datasets of competencies, thereby creating a flex curriculum in response to a prompt and/or an input dataset. The input dataset may be a complex query or prompt to an AI system with knowledge of course catalog descriptions and/or with course curricula that have been decomposed into constituent competencies. The prompt may be a text prompt that contains descriptive text of regarding a job or a set of competencies desired by an applicant. An input dataset may be a job description, for example, that has been received from an employer or a job postings board. Language in the prompt or the input dataset may be matched to course descriptions or constituent competencies by a large language model trained on institution course catalogs.

Embodiments of the invention have certain advantages. By matching applicant experience data with existing coursework, with and without constituent competency decomposition, systems according to a first embodiment may provide applicants with a quicker path to a degree or certification that fairly makes use of previous education or on the job experience. Additionally, systems operating according to a second embodiment can generate progressions of course work specifically tailored to descriptions of work functions. This raises the possibility of institutions generating custom, flexible course progressions for specific jobs. It is foreseen that such automatically series of courses will be particularly useful for multi-disciplinary fields such as business, where specific sets of both technical and business-oriented coursework can be constructed in response to queries.

### BRIEF DESCRIPTION OF THE DRAWINGS

Aspects of the disclosure will be better understood after reading the following description when considered with the drawings in which:

FIG. 1 is a conceptual block diagram illustrating an example of a hardware implementation for an online computer system 100, usable to realize competency-based flex curricular matching system according to an embodiment of the invention

FIG. 2 is a flowchart showing data receipt and matching steps for a computer implemented method of matching applicant experience to existing coursework;

FIG. 3 is a flowchart showing steps for a computer implemented method of generating flexible coursework in response to queries.

FIG. 4 is a block diagram showing functional modules operating according to an embodiment of the invention.

FIG. 5 is a knowledge graph that may be provided as user interface output information displays as a result of certain embodiments.

FIG. 6 is a knowledge graph that may be provided as user interface output information displays as a result of certain embodiments.

### DETAILED DESCRIPTION OF THE PREFERRED EMBODIMENTS

Reviewing a mid-career student or applicant's background to determine equivalent college credit is conventionally a manual process. Conventionally, a counselor or other intake professional scrutinizes a mid-career applicant's resume as well as other supplied application materials, and then makes a judgment to determine whether certain degree or certification requirements may be redundant. This manual review process may be supplemented with candidate interviews. This process is, however, time consuming and may yield imperfect results. Additionally, this manual review process may yield inconsistent results, where a given reviewer, or multiple reviewers, may treat similarly qualified students differently.

In certain systems this manual review process may be supplemented by course equivalency tables that map correspondence between the subject matter of various courses offered at other four-year or two-year institutions. These tables are built manually, typically by reviewing course catalogs from various institutions and trying to manually match keywords in the course descriptions to one another. The result of this process is a highly uncertain correspondence between courses at different institutions. Typically, the entity building course equivalency tables does not have access to course syllabi or other detailed materials, which may change from year to year. Even if the entity building the equivalency table has access to internal institution data, it may not have access to this sort of highly detailed data from other institution. Moreover, such course equivalency tables do not, and do not purport to attempt to make a judgement as to equivalency between institution coursework and other experience such as work or military experience or industry certifications. Additionally, to be useful, this sort of equivalency data must constantly curated, which is a laborious process and is typically not well done. Additionally, current attempts at extending college credit on the basis of user experience involve judgments that are difficult to articulate to an applicant. Solutions to these conventional problems are provided in the inventive embodiments described below.

Some of the functional computing and data units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for example, comprise one or more physical or logical blocks of computer instructions which may, for example, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference to a signal bearing medium, input or output may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, punch card, flash memory, integrated circuits, or other digital processing apparatus memory device. Signals, inputs or outputs may be persistent or transitory depending on the medium.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams or figures showing arrangement and connectivity between modules they are understood not to limit the scope of the corresponding method. Indeed, some arrows or other connectors may be used to indicate only the logical flow of one method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Where, “data storage media,” or “computer readable media” is used, Applicants mean an information storage medium in combination with the hardware, firmware, and/or software, needed to write information to, and read information from, that information storage medium. In certain embodiments, the information storage medium comprises a magnetic information storage medium, such as and without limitation, a magnetic disk, magnetic tape, and the like. In certain embodiments, the information storage medium comprises an optical information storage medium, such as and without limitation, a CD, DVD (Digital Versatile Disk), HD-DVD (High Definition DVD), BD (Blue-Ray Disk) and the like. In certain embodiments, the information storage medium comprises an electronic information storage medium, such as and without limitation, a PROM, EPROM, EEPROM, Flash PROM, compactflash, smartmedia, and the like. In certain embodiments, the information storage medium comprises a holographic information storage medium.

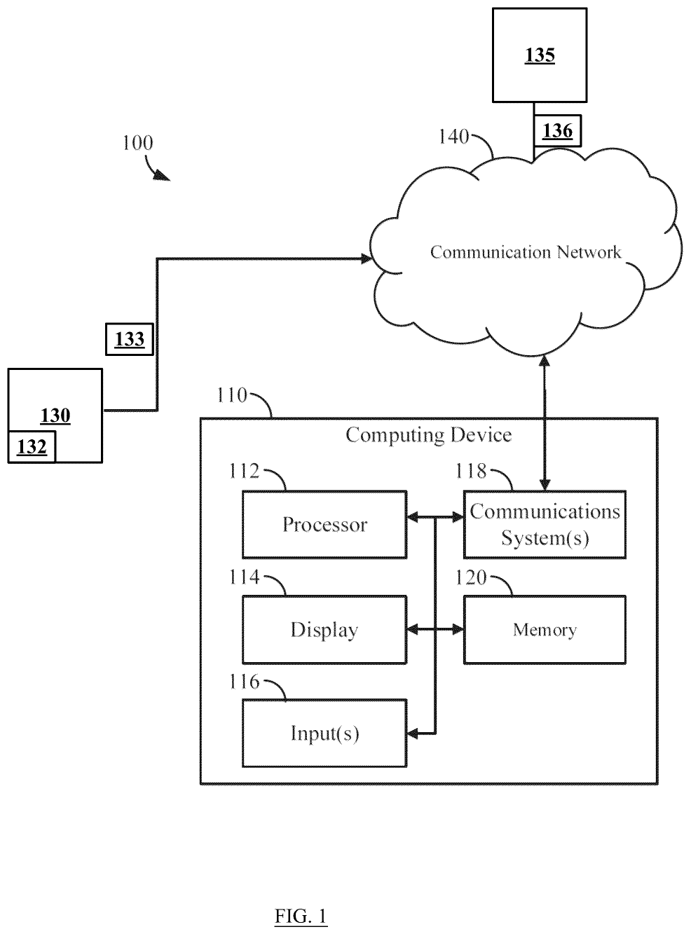

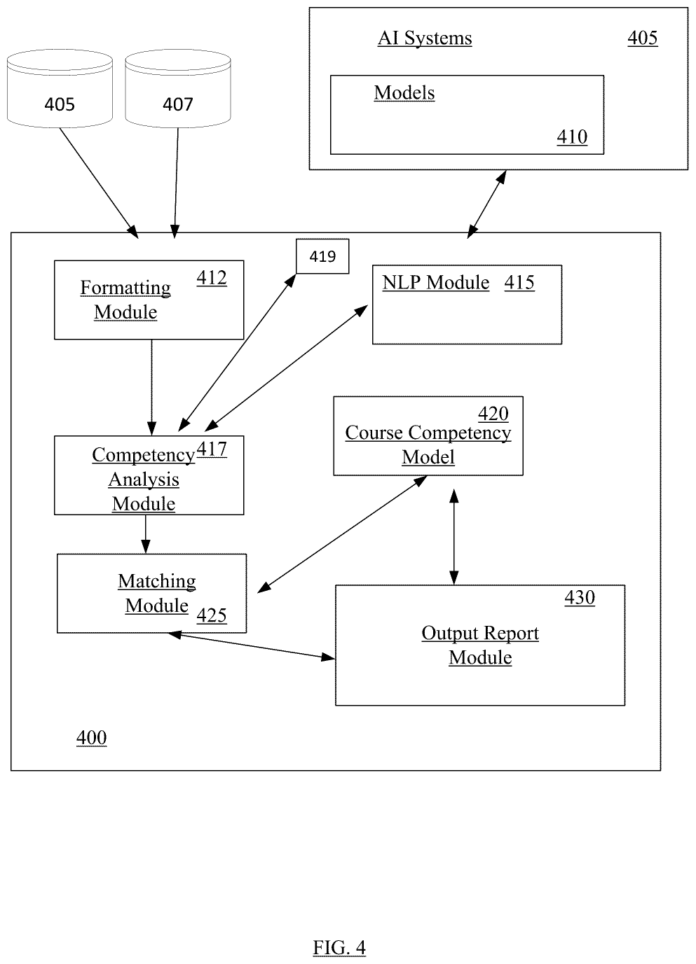

Several embodiments below are described as a series of method steps, which may include optional steps. It should be understood that the steps of these embodiments are carried out in computing environments (e.g., the environments of FIGS. 1 and 4) by computers having programmable processors and the other features typical of computing devices (e.g., data input/output devices, network interface cards supporting wired or wireless communication with other processors, volatile and non-volatile memory, etc.). Additionally, the method steps discussed below may be encoded on a non-volatile, computer readable memory, which encodes computer executable instructions, which, when executed by a processor cause the processor to perform, or direct other devices to perform, the recited method steps.

FIG. 1 shows an example 100 of a system for matching applicant experience to existing course offerings. As shown in FIG. 1, a computing device 110 can receive and process applicant data 130, including experience data according to an AI/LLM driven matching model. The matching models are encoded in and applied in accordance with computer executable instructions stored in memory 120, which may be volatile or non-volatile, and local or cloud based. Preferably the matching model is a trained AI that has been configured to detect the similarity between input data vectors and previously presented input data vectors on which the AI has been trained.

In the system of FIG. 1, the computing device 110 can electronically communicate with a number of data sources and/or system users (e.g., applicants 130, and third-party data providers 135) to receive a variety of previously stored and contemporaneously generated data (e.g., applicant experience data 133, and third-party data 136) over a communication network 140. Computing device 110 may also communicate information to one or more of these entities over the same communication network. Here, applicant 130, and third-party data provider 135 are presented as examples of entities with which the system can communicate to gather applicant experience data, either from the applicant itself, or some third party like educational institutions the applicant previously attended. An applicant 130 will generally be an individual using its own computing device (constituted like device 110) in communication with device 110, and third-party data provider 135 may be another individual user of the systems, computing devices being used by users, or some combination of these. In cases where these third-party data sources are computing devices, they may be constituted with the general-purpose features of computing device 110 described herein. They may also exist in a client-server relationship with computing device 110.

In a preferred arrangement, an applicant supplies student applicant experience data 133 to the system (i.e., to computing device 110) through an applicant facing user interface (UI) 132. The applicant facing UI 132 may be generated by an application running on the student's computing device, or it may be a web app running from computing device 110. Optionally, the student facing UI is, or is supplemented by an artificial intelligence interview bot (“AIIB”)—an automated process that may include a question tree (i.e., a script) and a natural language processing engine for evaluating and categorizing responses and navigating the question tree. Preferably, the AIIB is designed to elicit information about student experiences and to store that information and supply it to the system in a standardized format, e.g., with standardized keywords recognizable by the system. Applicant experience data may be communicated anonymously, for example, with a unique identity token that is stored at the system computing device 110 (e.g., in database memory 120) in association with the applicant data. It is contemplated that the student facing UI 132 may be generated by an application running at a computing device local to the student, or it may be a web-based or cloud-based application being generated by computing device 110.

Additionally, third parties 135 may supply third-party data 136 relating to the applicant to computing device 110 over the communication network 140. The third-party data is generally institution data, for example, data about courses taken and/or degrees and certifications already obtained by the applicant. Third party data may also be formalized records regarding employment such as military records, which include information about the work experiences of the Applicant.

In some examples, the communication network 140 can be any suitable communication network or combination of communication networks. For example, the communication network 140 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 140 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In the system 100 of FIG. 1, the computing device 110 can be any suitable computing device or combination of devices, such as a desktop computer, a laptop computer, a smartphone, a tablet computer, a server computer, or a virtual machine being executed by a physical computing device, etc. In some examples, the computing device 110 can train and/or run the AI matching system. In other embodiments, different computing devices can divide the aforementioned training and execution steps.

In further examples, the computing device 110 can include a processor 112, a display 114, one or more inputs 116, one or more communication systems 118, and/or memory 120. In some embodiments, the processor 112 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc. In some embodiments, the display 114 can include any suitable display devices, such as a computer monitor, a touchscreen, a television, an infotainment screen, etc. In some embodiments, the input(s) 116 can include any suitable input devices and/or sensors that can be used to receive user input, such as a keyboard, a mouse, a touchscreen, a microphone, etc.

In further examples, the communications system(s) 118 can include any suitable hardware, firmware, and/or software for communicating information over communication network 140 and/or any other suitable communication networks. For example, the communications system(s) 118 can include one or more transceivers, one or more communication chips and/or chip sets, etc. In a more particular example, the communications system(s) 118 can include hardware, firmware and/or software that can be used to establish a Wi-Fi connection, a Bluetooth connection, a cellular connection, an Ethernet connection, etc.

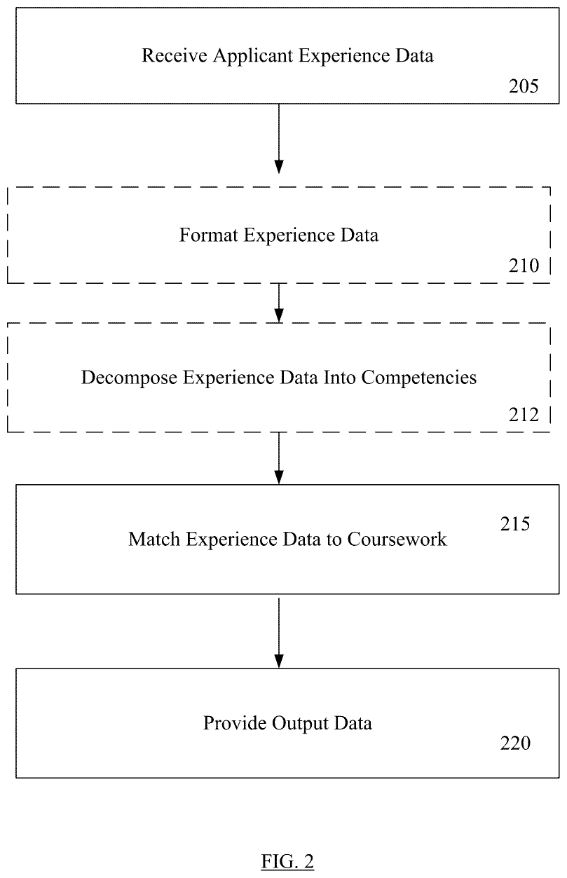

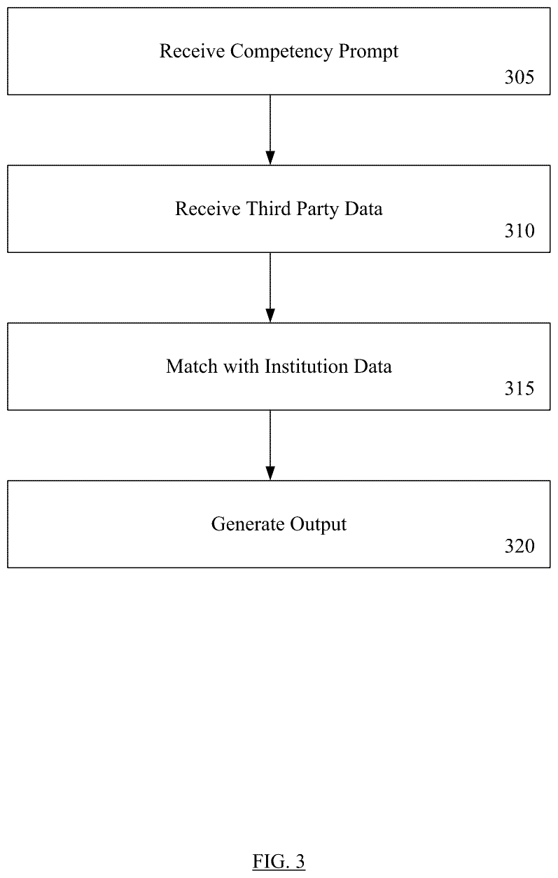

In further examples, the memory 120 can include any suitable storage device or devices that can be used to data, instructions, values, AI models, etc., that can be used, for example, by the processor 112 to compare student, institution and alumni data. The memory 120 can include any suitable volatile memory, non-volatile memory, storage, or any suitable combination thereof. For example, memory 120 can include random access memory (RAM), read-only memory (ROM), electronically-erasable programmable read-only memory (EEPROM), one or more flash drives, one or more hard disks, one or more solid state drives, one or more optical drives, etc. In some embodiments, the memory 120 can have encoded thereon a computer program for controlling operation of computing device 110. For example, in such embodiments, the processor 112 can execute at least a portion of the computer program to perform one or more data processing and matching, and output tasks described herein and/or to train/run AI matching systems described herein, present content to the display 114, transmit/receive information via the communications system(s) 118, etc. As another example, processor 112 can execute at least a portion of processes described below in connection with FIGS. 2-3.

FIG. 2 is a flow chart showing the steps of receiving applicant and third-party experience data and performing a matching process to match the applicant experience data with coursework. The FIG. 2 process begins (205) with collection and receipt of applicant experience and student data in the custody of third parties (such as institutions previously attended). The applicant experience data may be a list of competencies learned during the applicant's job history, on-the-job tasks mastered, certifications issued by third parties already received, and coursework completed at other institutions. Applicant experience data may also be received from third parties such as previous employers, previously attended educational institutions, employment and networking websites, such as Linkedin, etc.

At step 210, the system may execute an optional step of formatting the applicant experience data received at step 205. Formatting may include mapping keywords located within the applicant experience text to other keywords that will be more easily recognized and interpreted by the matching process. Examples of this remapping of experience data would include translation to English or some other localization and rewriting acronyms in long form. Additionally or alternatively, in a non-illustrated step and as is set forth above, the system may elicit applicant experience data in real time through an AIIB. According to this process, the system elicits applicant experience data in a predetermined format so that the experience data are expressed in language that can be easily matched with educational offerings. This interview process may assist with the same AI driven competency decomposition process described below, that is to say, on the basis of correlations between experience descriptions and known competencies in historical training data. In one aspect, the process may guess at competencies embedded in applicant experience descriptions, and then the interview process can prompt the applicant to confirm or deny the competencies.

At step 212, the system may execute an optional, but preferred, step of decomposing the applicant experience data into sub-data directed to individual competencies. In this step, the system generates, for one or more experiences, competencies associated with that experience. For example, if the applicant data includes “design and fabricate precision metal components for vehicles”, the system may decompose this into: “computer aided design”, “computer aided manufacturing”, “skilled machining” and “automotive technology”. The system may use a natural language processing (NLP) engine to, e.g., identify implicit skills or experience in the explicit text. For example, in the foregoing example, an NLP engine may perform implicit content analysis (in a manner similar to conventional sentiment analysis) to extract “hands on competency” or even “creativity” from the text “design and fabricate precision metal components”. In certain embodiments, a confidence score is generated and applied to the individual competencies. The confidence score may be based on historical data (e.g., historical training data) in which previous individuals with known or verified competencies have been passed through the system. The training data may be used to train an AI process (e.g., a neural network) to associate experience descriptions with known competencies in the historical data.

In step 215, the applicant experience data is matched with data regarding course offerings from an educational institution. In one embodiment, the institution implementing the system has access to course data (i.e., descriptions of courses from a catalog, but preferably detailed curriculum data from courses). The matching process may involve supplying a prompt to a LLM or other AI system to the effect of “find courses that correspond to or are similar to the experiences listed in the applicant experience data”. In a preferred embodiment, the matching process is performed at the competency or skill level. In this process, course data from the institution has been decomposed into competencies conferred in each course, applicant competencies are matched on a competency-by-competency basis, and then a full or partial match is determined from the number and significance of matched competencies.

Optionally, the AI/LLM system may be capable of implementing explainable AI (XAI) techniques to make the matching process (steps 215, 315 below) transparent. In these cases, the system, as part of its output reports, provides explanations for why specific courses or competencies were matched (or not matched) to an applicant's experience. This overcomes one difficulty with conventional processes because users have complete transparency into the process, which builds trust with both applicants and administrators.

In step 220, the system provides output data. Output data may include one or more of: a list of courses for which the applicant's experience matches, a list of competencies for which the applicant's experience matches, and/or a list of courses for which an applicant's experiences are a partial match. The institution may then offer the applicant credit for courses for which a complete match is determined. Additionally, if, based on competency matches, the system determines a partial match for a course, the system may offer the applicant a customized curriculum to enable the applicant to obtain the missing competencies to achieve full course credit. For situations requiring testing out or addressing partial matches, the system, in some cases, generates personalized assessments focused specifically on the missing competencies identified during the matching process, which personal assessment may include a make-up curriculum consisting of full or partial make-up courses. This make-up curriculum may preferably be offered as a course of self-study. Alternatively or additionally, and for any degree of match, the system may offer the applicant the opportunity to take a test for full or partial credit. For example, if the system determines a high level of partial match, the applicant may be given the opportunity to test for credit for the entire course, on the assumption that full competency may be obtained with a small amount of self-study.

Optionally, as part of the matching process of step 215, the system may assign a confidence score to each matching determination indicating a degree of confidence that the applicant has obtained a competency or knowledge corresponding to the full course. Testing and/or self study may preferably be offered for courses or competencies for which the confidence score falls below a threshold. Self-study may be offered for competencies that fall below a first threshold, and directly testing for credit may be offered for competencies falling above the first threshold but below a second, higher threshold.

FIG. 3 illustrates method steps according to a second embodiment of the invention. In the method of FIG. 3, the goal is to generate a flexible, custom and ad hoc course of study in response to specific prompts supplying detail about a job or a collection of competencies. In step 305, the system receives a prompt. In certain cases, the prompt is received from an applicant as applicant data. In these cases, it is assumed that the applicant is interested in a course of study that will position the applicant for success in a particular job field. The prompt may be a job or task description, but preferably, it includes a list of competencies or even certifications that the applicant knows will be useful on the job. In step 310, the system searches for, elicits, and/or receives third party data relevant to the job prompt. This data may include data on third party certifications helpful for workers in the field of the job prompt. In step 315, an AI/LLM driven matching process locates course work, or individual competencies within course curricula, that are relevant and/or similar to the prompt information. Preferably, this matching process takes place with input from the institution's entire course offering, and is therefore multidisciplinary. For example, a prompt such as “equip students with the necessary knowledge and skills to start, operate, and manage a successful robotic support animal business, considering both technical and business aspects” may preferably generate a list of courses or competencies spanning both engineering and business fields, returning courses in robotics, control theory, and startup/venture development from a business college. In step 320, an output is generated, which is preferably a flex curriculum that may be offered by the institution to the applicant that is directly tailored to the prompt. Optionally, the institution may offer a custom certificate or other certification that is awardable to the applicant upon completion of the custom curriculum.

FIG. 4 schematically illustrates a computing environment including one or more interconnected executable modules and data stores. As is set forth above, the modules may be executed on a single computer's programmable processor or may be executed across several difference processors on different machines, such as a server and one or more clients. A student/applicant user of the system may be possession of one machine and an institution may be possession of another machine. The various machines that, together, constitute the system of FIG. 4 may be in networked electronic data communication with one another over one or more data communication channels carrying electronic data signals.

FIG. 4 shows a curriculum planning system 400. System 400 is preferably a computer implemented process running a server computing device in possession of an institution, such as a post-secondary educational institution. System 400 receives data from one or more, and preferably at least two, data stores 405 and 407. Data store 405 includes student/applicant data, which will be referred to here as “student data”. Student data may be stored in electronic data storage (transitory or non-transitory) at any location, such as at a storage device on a student computing device or at a storage device on a server computing device at the institution. Data store 405 contains one or more data records containing information about the student's experience and background. The data record(s) may include copies of educational institution transcripts, application materials that have been filled out by the student, military service records, resumes or CVs, or any other written record showing student experience or education in electronically stored form. System 400 is also in communication with third party data store 407. Third party data store 407 may be located on a machine in the possession of another institution or entity (e.g., an educational institution attended by the student, LinkedIn, etc.). Third party data store 407 contains one or more data records, which may include transcripts, course catalogs containing course descriptions curricula and lesson plans associated with courses, narrative work histories, and other data relevant to the student's past experience. In most embodiments, system 400 also has access to a third and internal data store at the institution in possession of the server that also has course catalogs, curricula and lesson plans, etc., that are relevant to past student experience and/or courses for which a student may be recommended or receive credit. These data records will be referred to as descriptive course data, and in most cases they will be more detailed and comprehensive than course data received from third parties because, internally, system 400 is likely to have access to detailed lesson plans, curricula and even actual written and audiovisual course materials. The descriptive course data will generally include data regarding the skills and competencies that will result from taking the course, as well as course prerequisites.

System 400 receives the data records from the data stores described above and applies them to formatting module 412. Formatting module reformats received student and course data to make it more easily parsable by the competency analysis module. This task may include tasks such as applying an optical character recognition routine to student data documents, localization (i.e., translating non-English words to English words), rewriting acronyms in long form, transforming certain experience labels into equivalent terms used in the institution's own descriptive course data and the insertion of synonym keywords into the student data. Extraneous data may also be filtered, e.g., data relating to personal interests or the like. A similar process may be performed on third party data. Formatting module 412 may also transform documents having multiple document file formats to a single format that includes OCR text data, such as an OCR enabled .pdf file. Formatting module 412 may also concatenate these transformed documents into a single document that consolidates all student data.

In certain embodiments, this same formatting process is applied to third party data and to the institution's own descriptive course data. While substantive localization of the institution's own data is not likely to be necessary (the goal is to transform the student supplied data and third party data about the student into equivalent language already used by the institution), some formatting of institution data is possible. In any event, the institution data may be OCRed and concatenated into a single, text recognizable file for easy submission to a skill/competency extraction module later.

System 400 passes the formatted data to competency analysis module 417. Competency analysis module is configured to transform the formatted student data into a first data structure including a list of skills or competencies. In preferred arrangements, the transformation of student data to the first transformed data is done with the assistance of a NLP engine 415, which can read the formatted student data and generate a list of skills/competencies reflected therein. In some cases, the NLP engine can generate a report a confidence score for its natural language extraction process, which may be used to tune the NLP engine after manual review. Competency analysis module 417 (also referred to herein as an extraction module) may optionally call a UI module 419, which is used to elicit feedback on the accuracy of the extracted skills/competencies from the student. In some cases, UI module 419 may also query internal personnel if it is being run to build skills/competency data from internal course description data.

System also has access to course competency model 420. Model 420 may be built by analyzing internal descriptive course data, from the third and internal data store mentioned above, transforming that data into lists of skills/competencies by course, and storing that transformed data in a course model. Thus, course competency model 420 reflects the transformation of formatted descriptive class data into a second data structure that includes a list of skills or competencies taught by various classes. Additionally, it optionally reflects transformed formatted descriptive class data into a third data structure that includes a list of skills or competencies that are prerequisites for various classes. It is contemplated that these second and third processes may be conducted once, or periodically (e.g., yearly, or each semester as new classes are offered and as curricula are revised), and the resulting transformed datasets stored in course competency model 420. In some instances, this transformation process may make use of NLP module 415. In some instances, the extraction of skills/competencies from course materials can be used to train an AI/LLM model 410, to configure an AI or LLM to associate certain course descriptions with lists of skills/competencies and prerequisites.

Once skills/competencies are extracted from the student data, they are matched by matching module 425 against similar lists of skill/competencies stored in the course competency model 420, which again, houses data structures that include courses and associate those courses will skills/competencies learned upon completion and with prerequisite skills/competencies. Because the raw student data and the course data have been decomposed into lists of skills/competencies, this matching process can be performed on a skill-by-skill basis, which results in a high degree of accuracy in the matching. In a simplest case, matching may be done on a keyword basis, by matching skills identified and extracted by the analysis engine to skills in the course model. However, preferably, the matching is performed by querying an AI system or an LLM 405. In the case of an AI system, the system may be a neural network has an input and output network linked by a variable weighted nodes that interconnect a set of inputs to a set of outputs. The network or models 410 can be trained on historic data. The training may involve providing the network with elements of student data, either raw or formatted data, and then observing skills identified at the output of the network. Feedback can be provided to positively reinforce the network by identifying skills that the student actually had and reinforcing network paths that identify those skills while decreasing the weight of paths to spurious skills. Actual student skill data can be generated by polling students in a training set of students, or on the basis of courses (for which the skills are known) that the student has successfully completed. In other embodiments, an LLM trained on material such as course syllabi and course material (i.e., course readings, transcribed lectures, etc.), can be asked to make predictive associations between the student data and skills.

In addition to matching student skills (from work experience or coursework typically) to coursework for the purpose of giving course credit to the student, matching module 425 also matches the student skill data record to course prerequisites. This process may be used to suggest a course of student to the student, i.e., matching the student to courses to be taken, rather than courses for which the student has already effectively earned credit.

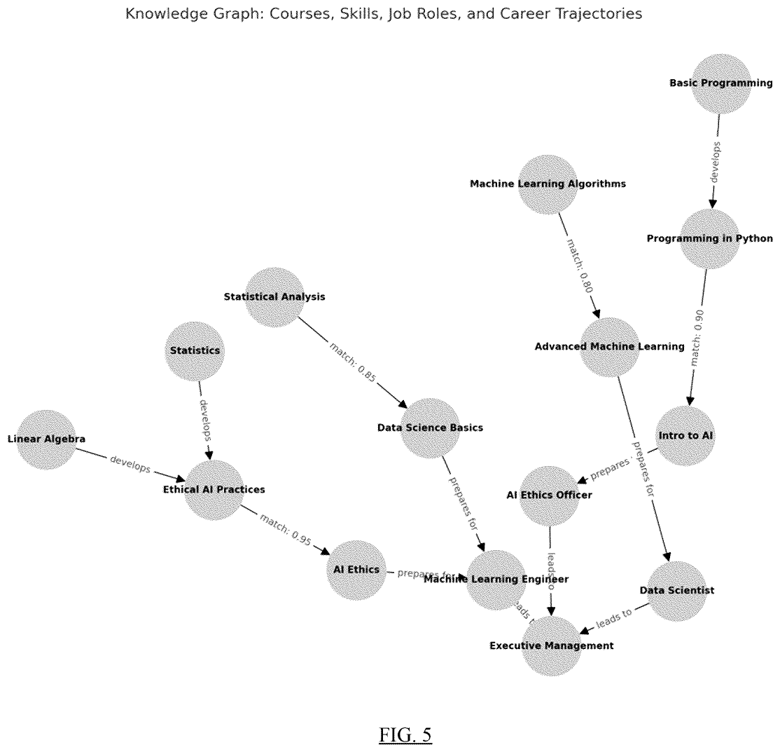

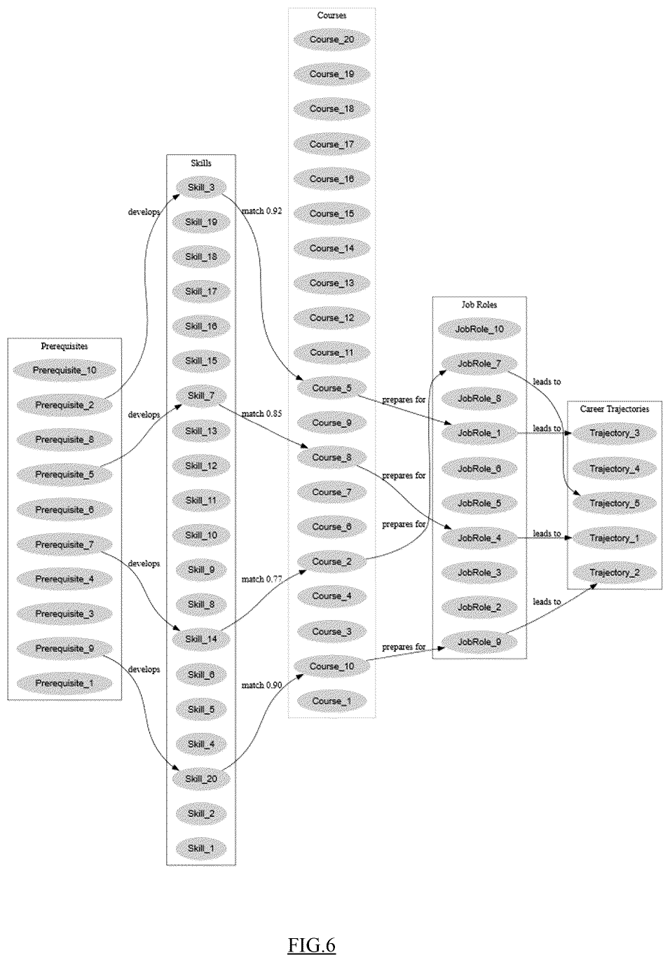

The matching module 425 generates a data record reflecting probabilistic matches of the student's skills and competencies to skills and competencies of institution courses reflected in the course competency model 420. The record may identify a skill possessed by the student, and then associate that skill with one or more courses. The matching module 425 may associate a score (i.e., a matching score reflecting confidence) with each match, and this may be reflected as well. This output data record may be reflected and formatted for display on various computer user interfaces in various ways. For example, one or more knowledge graphs may be generated that show the result of the matching process and contain information regarding confidence of the match. Some examples are depicted in FIGS. 5-6.

FIG. 5 shows an example knowledge graph illustrated the outcome of the matching process described throughout this disclosure. In the example of FIG. 5, an incoming student or applicant has associated student data, which may be student-supplied or taken from third party sources. Here, the student data may include previous course work (e.g., linear algebra, statistics), which are easily extracted into skills/competency in a straightforward manner. The student may also have certain work experience, that has been transformed into additional skills (statistical analysis, machine learning algorithms, basic programming). The process identifies courses for which the student may take going forward on the basis of matching skills to prerequisites (E.g., Ethical AI Practice and Python). The confidence of the match is reflected, with a lower than 100% confidence score suggesting a partial match, which can prompt an additional course of self-study. This process can also be carried forward into the student's career by incorporating career trajectories. Each competency in this case is presented as a node from which the student may move to a next competency on the path to some ultimate career.

The matching process is presented in a more generic form in FIG. 6. Referring now to FIGS. 4 and 6, course prerequisites can be extracted from descriptive course data and stored in the course competency model. These data structures may list a prerequisite or a competency associate that priority with one or more courses in the course competency model, which may be a relational database. The matching process may match prerequisites to skills extracted from the student data. On the basis of this matching, the system may output a report that suggests courses that have the matched prerequisite that the student would be qualified to take. Additionally, if the AI process assisting the matching process has been trained on historical data regarding post-secondary career paths (e.g., of actual students), further recommendations may be output for the student, such as available job roles and career paths.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A computer implemented method for matching educational institution applicant experience to institution coursework, the method comprising:
receiving from the applicant a plurality of documents including data reflecting an applicant's previous experience;
formatting the applicant data with a formatting module to generate a single applicant data file reflecting the applicant data in the plurality of documents;
extracting from the applicant data file an applicant data record listing applicant competencies with a competency analysis module;
using a matching module to match competencies in the applicant data record with competencies stored in a course model, wherein the course model contains course data records each associating a course with both competencies learned in the course and competencies required to take the course;
generating a matching output report with an output report module, the output report causing a computer user interface to display courses for which the applicant has the course competency and courses available for the applicant to take.

2. The method of claim 1, wherein receiving from the applicant a plurality of documents including data reflecting an applicant's previous experience comprises receiving from a third party computing device applicant data regarding certifications received by the applicant and previous institution coursework.

3. The method of claim 1, wherein extracting from the applicant data file an applicant data record listing applicant competencies with a competency analysis module comprising mapping applicant experience data to a set of predetermined keywords.

4. The method of claim 1, wherein extracting from the applicant data file an applicant data record listing applicant competencies with a competency analysis module comprises supplying a prompt to an AI or LLM, wherein the prompt comprises predetermined keywords relating to competencies.

5. The method of claim 1, further comprising assigning a confidence score to matches between competencies in the applicant data record with competencies stored in a course model, and wherein matching output report comprises indications of the confidence score.

6. The method of claim 1, wherein formatting the applicant data with a formatting module to generate a single applicant data file reflecting the applicant data in the plurality of documents comprises subjecting the applicant data to an optical character recognition process, and wherein, the single applicant data file is text searchable.

7. The method of claim 1, wherein using a matching module to match competencies in the applicant data record with competencies stored in a course model comprises directing the matching module to formulate a prompt to an AI or LLM trained on course data records to perform a matching task.

8. The method of claim 1, further including using the matching module to partially match competencies in the applicant data record with competencies stored in a course model, and wherein the matching output report includes a record of partial matches to competencies learned in a course and competencies required to take a course.

9. The method of claim 1, further comprising using the matching model to identify, for partial matches, course competencies not matched to an applicant data record.

10. The method of claim 1, further comprising using the output report module to generate one or more knowledge graph graphically depicting student competencies and mapping those competencies to competencies required as prerequisites for courses and competencies provided by successful completion of courses.

11. The method of claim 10, wherein a knowledge graph further includes an indication of a confidence score associated with each mapped connection between a student competency and a course competency.

12. The method of claim 1, wherein the matching output report is formatted to further include career role and/or career path recommendations as a result of a competency matching process.
